(19) United States
(12) Patent Application Publication
(10) Pub. No.: US 2023/0241548 A1
(43) Pub. Date: Aug. 3, 2023

(54) SYSTEMS AND METHODS FOR PREVENTING THE FORMATION OF CARBONYL SULFIDE

(71) Applicant: MARATHON PETROLEUM COMPANY LP, Findlay, OH (US)

(72) Inventors: William L. Holland, Findlay, OH (US); Todd M. Becker, Findlay, OH (US)

(21) Appl. No.: 18/103,318

(22) Filed: Jan. 30, 2023

Related U.S. Application Data
(60) Provisional application No. 63/267,384, filed on Jan. 31, 2022.

(51) Int. Cl. B01D 53/14; C01B 32/50; C01B 32/40; B01D 53/04; B01D 53/18

(52) U.S. Cl. CPC B01D 53/1462; C01B 32/50; C01B 32/40; B01D 53/1425; B01D 53/04; B01D 53/1418; B01D 53/18; C01B 2210/0003; C01B 2210/0015; B01D 2253/1124; B01D 2257/304; B01D 2252/204

(57) ABSTRACT

Systems and methods for preventing formation of carbonyl sulfide in the production of sweet gas using an amine-lean aqueous solution and metal oxide adsorbent material. In embodiments, a method may include producing, via an amine absorption column supplied with a raw gas stream that includes fractions of hydrogen sulfide (H₂S), carbon dioxide (CO₂), and carbon monoxide (CO), (1) a sweet gas stream that includes the fractions of the CO and (2) an amine-rich aqueous solution that includes the H₂S and CO₂. The method may include heating the amine-rich aqueous solution to produce a heated amine-rich aqueous solution. The method may include producing, via an amine regenerator supplied with the heated amine-rich aqueous solution (1) an acid gas stream that includes the H₂S and CO₂ and (2) an amine-lean aqueous solution. The method may include producing, via adsorption in a metal oxide adsorbent vessel, an effluent stream that includes the CO₂.

### CROSS-REFERENCE TO RELATED APPLICATIONS

The present application claims priority to and the benefit of U.S. Provisional Application No. 63/267,384, filed Jan. 31, 2022, titled “SYSTEMS AND METHODS FOR PREVENTING THE FORMATION OF CARBONYL SULFIDE,” the disclosures of which is incorporated herein by reference in its entirety.

### FIELD OF DISCLOSURE

The present disclosure relates to systems and processes for reducing the formation of carbonyl sulfide (COS) using an amine-lean aqueous solution and metal oxide adsorbent material. More specifically, the present disclosure relates to systems and processes for prevention of the formation of COS in the production of sweet gas.

### BACKGROUND

Contaminants, such as hydrogen sulfide (H₂S) and/or carbon dioxide (CO₂), in raw gas can lead to issues in pipelines and processing facilities. Pipeline companies may set strict standards of operations for compositions of unwanted constituents with respect to the pipeline to avoid disruptive processes including souring and corrosion. Removal processes of unwanted constituents may remove some of the unwanted constituents but form new unwanted constituents, such as Carbonyl Sulfide (COS), in the process.

### SUMMARY

Applicants have recognized these problems and disclose embodiments of solutions in relation to treating a raw gas stream with an amine-lean aqueous solution that reduces or substantially prevents the formation of carbonyl sulfide (COS), thus avoiding issues caused by such constituents in pipelines and downstream facilities.

The present disclosure is directed to embodiments of methods and systems for preventing formation of COS in the production of sweet gas. For example, the present disclosure includes a method for preventing formation of COS in the production of sweet gas. The method may include supplying a raw gas stream that includes fractions of two or more contaminants and fractions of carbon monoxide (CO) to an amine absorption column. Amine absorption columns will be understood by those skilled in the art. The two or more contaminants, for example, include hydrogen sulfide (H₂S) and carbon dioxide (CO₂). Additionally, an amine-lean aqueous solution may be supplied to the amine absorption column. The amine-lean aqueous solution may be capable of absorbing the fractions of the two or more contaminants.

The method may further include operating an amine absorption column at a first selected temperature range and a first selected pressure range so that the amine-lean aqueous solution absorbs the fractions of the two or more contaminants. As such, a sweet gas stream that includes the fractions of the CO may be produced and an amine-rich aqueous solution that includes, for example, thermal labile salts may be produced based on the interaction between one or more of the fractions of the two or more contaminants and the amine-lean aqueous solution.

In some embodiments, the sweet gas stream that includes the fractions of the CO may be outputted for supply to a hydrogen facility. The amine-rich aqueous solution may be supplied to a first heat exchanger to produce a heated amine-rich aqueous solution. The heated amine-rich aqueous solution then may be supplied to an amine regenerator. The amine regenerator may be operated at a second selected temperature range and a second selected pressure range, such as to effect thermal breakdown of the thermal labile salts of the two or more contaminants, to produce an acid gas stream (which may also be referred to as a sour gas stream) that includes the two or more contaminants and the amine-lean aqueous solution.

The acid gas stream that includes the two or more contaminants may then be supplied to a metal oxide adsorbent vessel, for example, that separates the two or more contaminants by adsorption of the H₂S. The metal oxide adsorbent vessel may be operated to adsorb the H₂S to produce an effluent stream that includes CO₂. The effluent stream that includes the CO₂ may be directed for further use and/or processing.

Another embodiment of the disclosure, for example, is directed to a method for preventing formation of carbonyl sulfide in a production of sweet gas. The method may include producing, via an amine absorption column supplied with a raw gas stream that includes fractions of hydrogen sulfide (H₂S), carbon dioxide (CO₂), and carbon monoxide (CO), (1) a sweet gas stream that includes the fractions of the CO and (2) an amine-rich aqueous solution that includes the H₂S and CO₂. The method may include heating the amine-rich aqueous solution to produce a heated amine-rich aqueous solution producing, via an amine regenerator supplied with the heated amine-rich aqueous solution (1) an acid gas stream that includes the H₂S and CO₂ and (2) an amine-lean aqueous solution. The method may include producing, via adsorption in a metal oxide adsorbent vessel supplied with the acid gas stream, an effluent stream that includes the CO₂.

Another embodiment of the disclosure, for example, is directed to a method for preventing formation of carbonyl sulfide in the production of sweet gas. The method may include supplying a raw gas stream that includes fractions of two or more contaminants and fractions of CO to a portion of an amine absorption column. The two or more contaminants, for example, include H₂S and CO₂.

An amine-lean aqueous solution also may be supplied to a portion of the amine absorption column. The amine-lean aqueous solution may be capable of absorbing the fractions of the two or more contaminants.

Further, in the embodiment, the method may include operating the amine absorption column at a first selected temperature range and a first selected pressure range so that the amine-lean aqueous solution absorbs the fractions of the two or more contaminants. As such a sweet gas stream that includes the fractions of the CO and an amine-rich aqueous solution that includes, for example, thermal labile salts produced based on the interaction between one or more of the fractions of the two or more contaminants and the amine-lean aqueous solution.

In some embodiments, the sweet gas stream that includes the fractions of the CO may be output for supply to a hydrogen facility so that the amine-rich aqueous solution is purified and supplied to the amine absorption column, and the fractions of the two or more contaminants are disposed of.

Another embodiment of the disclosure, for example, is directed to a method for preventing formation of carbonyl sulfide in the production of sweet gas. The method may include operating an amine absorption column at a first selected temperature range and a first selected pressure range so that fractions of two or more contaminants of a raw gas stream are absorbed in an amine-lean aqueous solution. As such, a sweet gas stream that includes fractions of carbon dioxide (CO) for supply to a hydrogen facility and an amine-rich aqueous solution that includes fractions of the two or more contaminants may be produced. In the embodiment, the two or more contaminants may include H₂S and CO₂.

The method may further include heating the amine-rich aqueous solution to output a heated amine-rich aqueous solution that includes the fractions of the two or more contaminants. The method also may include operating an amine regenerator at a second selected temperature range and a second selected pressure range, such as to effect thermal breakdown of the two or more contaminants of the heated amine-rich aqueous solution, to produce an acid gas stream that includes the two or more contaminants and the amine-lean aqueous solution. A metal oxide adsorbent vessel, for example, may be operated to adsorb the H₂S of the two or more contaminants in the acid gas stream to produce an effluent stream that includes CO₂.

Accordingly, another embodiment of the disclosure, for example, is directed to a system for preventing formation of carbonyl sulfide in the production of sweet gas. The system may include an amine absorption column positioned to receive a raw gas stream that includes fractions of CO and fractions of two or more contaminants including H₂S and CO₂ at a portion of the amine absorption column. The amine absorption column also may receive an amine-lean aqueous solution at a portion of the amine absorption column. In the embodiment, the amine absorption column may include packing or two or more trays to facilitate absorption of the fractions of the H₂S and the CO₂ at a first selected temperature range and a first selected pressure range. As such, a sweet gas stream that includes the fractions of the CO and an amine-rich aqueous solution that includes, for example, the thermal labile salts produced based on interaction between one or more of the fractions of the two or more contaminants (such as H₂S and CO₂) and the amine-lean aqueous solution.

The system also may include a first heat exchanger positioned to receive the amine-rich aqueous solution from the amine absorption column. The first heat exchanger may beat the amine-rich aqueous solution to produce a heated amine-rich aqueous solution.

The system further may include an amine regenerator positioned to receive the heated amine-rich aqueous solution from the first heat exchanger. In the embodiment, the amine regenerator may include packing or two or more trays to separate the fractions of the H₂S and CO₂ from the amine-rich aqueous solution at a second selected temperature range and a second selected pressure range. Accordingly, a fluid stream that includes the amine-lean aqueous solution and an acid gas stream that includes the fractions of the H₂S and the CO₂ may be produced.

The system also may include a metal oxide adsorbent vessel positioned to receive the fractions of the H₂S and CO₂. The metal oxide adsorbent vessel may adsorb the fractions of the H₂S to produce an effluent stream that includes CO₂. A combustion device may be positioned to receive and dispose of the CO₂ from the metal oxide adsorbent vessel. The CO₂ may be captured and sequestered. The CO₂ may be directed for further use and/or processing.

Another embodiment of the disclosure, for example, is directed to a system for preventing formation of carbonyl sulfide in the production of sweet gas. The system may include an amine absorption column positioned to receive a raw gas stream that includes fractions of CO and fractions of two or more contaminants including H₂S and CO₂ and an aqueous amine solution to facilitate absorption of the fractions of the H₂S and the CO₂ at a first selected temperature range and a first selected pressure range. In the embodiment, the amine absorption column may produce a sweet gas stream that includes the fractions of the CO to supply to a hydrogen facility and an amine-rich aqueous solution that includes the fractions of the two or more contaminants.

The system further may include a first heat exchanger positioned to receive the amine-rich aqueous solution from the amine absorption column. The first heat exchanger may beat the amine-rich aqueous solution to produce a heated amine-rich aqueous solution.

The system also may include an amine regenerator positioned to receive the heated amine-rich aqueous solution from the first heat exchanger to reduce the fractions of the H₂S and CO₂from the amine-rich aqueous solution at a second selected temperature range and a second selected pressure range. As such, a fluid stream that includes the amine-lean aqueous solution and an acid gas stream that includes the fractions of the H₂S and the CO₂ may be produced.

The system still further may include a metal oxide adsorbent vessel, for example, positioned to receive the fractions of the H₂S and CO₂, as will be understood by those skilled in the art. In the embodiment, the metal oxide adsorbent vessel may adsorb the fractions of the H₂S to produce an effluent stream includes CO₂.

Still other aspects and advantages of these embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features herein disclosed, will become apparent through reference to the following description and the accompanying drawings. Furthermore, it is to be understood that the features of the various embodiments described herein are not mutually exclusive and may exist in various combinations and permutations

### BRIEF DESCRIPTION OF DRAWINGS

These and other features, aspects, and advantages of the disclosure will become better understood with regard to the following descriptions, claims, and accompanying drawings. It is to be noted, however, that the drawings illustrate only several embodiments of the disclosure and, therefore, are not to be considered limiting to the scope of the disclosure.

FIG. 1 is a schematic diagram illustration of a system for preventing formation of carbonyl sulfide in the production of sweet gas, according to an embodiment of the disclosure.

FIG. 2A, 2B, 2C, 2D are schematic diagram illustrations of a system for preventing formation of carbonyl sulfide in the production of sweet gas with multiple metal oxide adsorbent vessels, according to an embodiment of the disclosure.

FIG. 3A is a schematic diagram illustration of a system for preventing formation of carbonyl sulfide when separating lighter and heavier hydrocarbons, according to an embodiment of the disclosure.

FIG. 3B is a schematic diagram illustration of a system for the separation of light hydrocarbons from heavier hydrocarbon to prevent formation of COS in the production of sweet gas and light hydrocarbons, according to an embodiment of the disclosure.

FIG. 4 is a simplified diagram that illustrates the system with a controller, according to an embodiment of the disclosure.

FIG. 5 is a simplified diagram, implemented in a controller, for controlling the system, according to an embodiment of the disclosure.

FIG. 6 is a simplified block diagram for preventing formation of carbonyl sulfide in the production of sweet gas, according to an embodiment of the disclosure.

FIG. 7 is a flow diagram that illustrates reducing COS, according to an embodiment of the disclosure.

### DETAILED DESCRIPTION

So that the manner in which the features and advantages of the embodiments of the systems and methods disclosed herein, as well as others, which will become apparent, may be understood in more detail, a more particular description of embodiments of systems and methods briefly summarized above may be had by reference to the following detailed description of embodiments thereof, in which one or more are further illustrated in the appended drawings, which form a part of this specification. It is to be noted, however, that the drawings illustrate only various embodiments of the embodiments of the systems and methods disclosed herein and, therefore, are not to be considered limiting of the scope of the systems and methods disclosed herein as it may include other effective embodiments as well.

It has been shown that the amount of COS generated in the production of sweet gas and light hydrocarbons, when an iron oxide based adsorbent is used to remove H₂S from a gas stream and when the carbonyl sulfide (COS) is in the presence of carbon monoxide (CO) and H₂S, is significantly above known equilibrium literate data. An amine based liquid treatment system removes the H₂S but minimally removes CO. COS that is not removed may be a potential catalyst poison and hazardous air pollutant.

The term “light hydrocarbons” may refer to propane, butane, pentane, other lighter hydrocarbons as will be understood by one skilled in the art, or some combination thereof. The term “heavy hydrocarbons” may refer to naphtha or heavier hydrocarbons, as will be understood by one skilled in the art. The term “sweet”, which may be used to describe any of the hydrocarbons herein, may refer to a hydrocarbon carbon stream that includes no amount, substantially no amount, significantly small amounts (such as up to about 10 parts per million (ppm) or about 1 to about 10 ppm) of H₂S. As described herein, an acid gas stream may refer to a hydrocarbon stream including fractions of H₂S and, in some embodiments, CO₂. The acid gas stream may also be referred to as a sour gas stream.

In the present disclosure, for example, one or more embodiments are directed to a system for preventing formation of carbonyl sulfide in the production of sweet gas. One such system may include an amine absorption column positioned to receive a raw gas stream that includes fractions of CO and fractions of two or more contaminants including H₂S and CO₂. The amine absorption column also receives an amine-lean aqueous solution to facilitate absorption of the fractions of the H₂S and the CO₂ at a first selected temperature range and a first selected pressure range. In the embodiment, the amine absorption column may produce a sweet gas stream that includes the fractions of the CO to supply to a hydrogen facility and an amine-rich aqueous solution that includes the fractions of the two or more contaminants. In some embodiments, the first selected temperature range is from about 95 degrees Fahrenheit (° F.) to about 150 degrees° F. and the first selected pressure range is from about 5 standard atmosphere (atm) of absolute pressure to about 20 atm. In some embodiments, the interaction between the amine-lean aqueous solution and the two or more contaminants generates thermal labile salts. Such interactions or processes may for the amine-rich aqueous solution including the thermal labile salts.

The system further may include a first heat exchanger positioned to receive the amine-rich aqueous solution from the amine absorption column. The first heat exchanger may beat the amine-rich aqueous solution to produce a heated amine-rich aqueous solution.

The system also may include an amine regenerator positioned to receive the heated amine-rich aqueous solution from the first heat exchanger to reduce the fractions of the H₂S and CO₂from the amine-rich aqueous solution at a second selected temperature range and a second selected pressure range to produce a fluid stream that includes the amine-lean aqueous solution and an acid gas stream that includes the fractions of the H₂S and the CO₂. In some embodiments, the second selected temperature range is from about 225° F. to about 275° F. and the second selected pressure range is from about 1 pounds per square inch gauge (PSIG) to about 15 PSIG.

The system further may include a metal oxide adsorbent vessel, for example, positioned to receive the fractions of the H₂S and the CO₂, as will be understood by those skilled in the art. The metal oxide adsorbent vessel may receive the fractions of the H₂S and the CO₂ at an upper or top portion of the metal oxide adsorbent vessel. The metal oxide adsorbent vessel may adsorb the fractions of the H₂S to produce an effluent stream that includes the CO₂. In some embodiments the amount of CO₂ from the metal oxide adsorbent vessel directed for further use and/or processing may be measured.

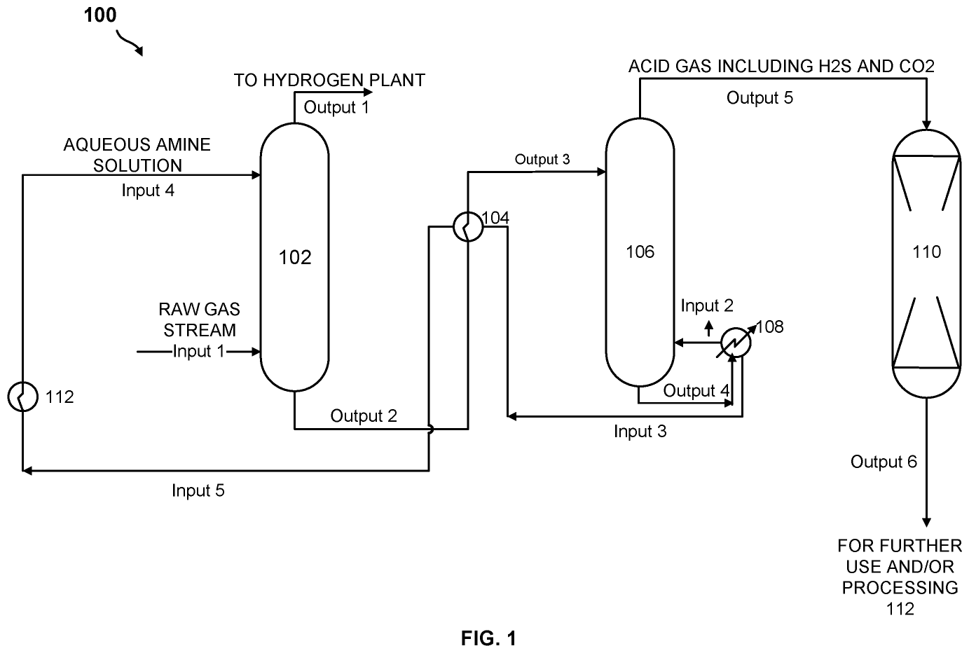

In one or more embodiments, as illustrated in FIGS. 1-5, the present disclosure is directed to embodiments of systems and methods for preventing COS formation in the production of sweet gas. In one or more embodiments, Input 1, Input 2, Input 3, Input 4, Output 1, Output 2, Output 3, Output 4, Output 5, Output 6 may be a pipe, pipeline, or a combination thereof.

An embodiment of a system 100 for preventing the formation of COS in the production of sweet gas is illustrated in FIG. 1. In FIG. 1, a system 100 for preventing formation of carbonyl sulfide in the production of sweet gas. The system 100 includes an amine absorption column 102 positioned to receive a raw gas stream at Input 1 that includes fractions of CO and fractions of two or more contaminants including H₂S and CO₂ at a portion of the amine absorption column 102. The raw gas stream may include one or more chemical species including hydrogen, methane, ethane, propane, hydrogen sulfide, carbon monoxide, carbon dioxide, or mixtures thereof.

The amine absorption column also receives an amine-lean aqueous solution at Input 4 at a portion of the amine absorption column 102. The amine-lean aqueous solution at Input 4 may comprise one or more amines including monoethanolamine (MEA), diethanolamine (DEA), 2-amino-2-methylpropanol (AMP), methyldiethanolamine (MDEA), piperazine (PIPA), or combinations thereof In some embodiments, the amine-lean aqueous solution, CS-2010, may be supplied from Ineos Gas Spec. The quality of the amine-lean aqueous solution may be inspected periodically to ensure the absorption properties are optimally working. Inspections may occur during the amine absorption process or after operation of the amine absorption column 102. Inspections of the amine-lean aqueous solution at Input 4 may occur manually. Inspections of the amine-lean aqueous solution at Input 4 may occur using spectroscopic techniques. Amine-lean aqueous solution at Input 4 out of spec may be exchanged from the system and replaced with new amine-lean aqueous solution. In some embodiments, the amine absorption column 102 may also receive a make-up water stream to supplement the amine-lean aqueous solution.

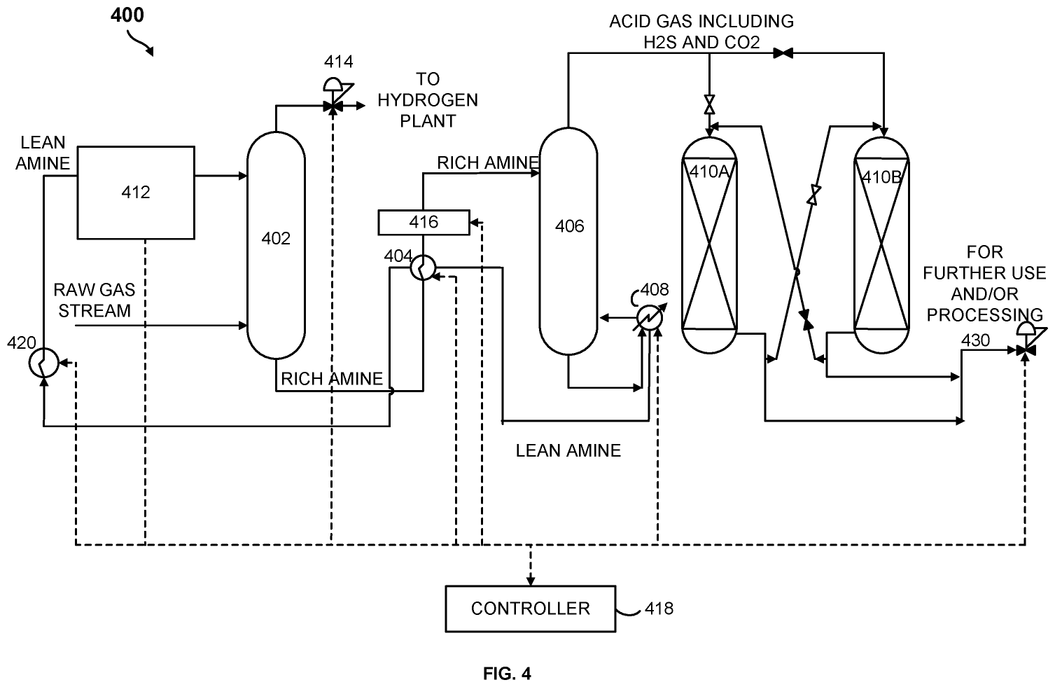

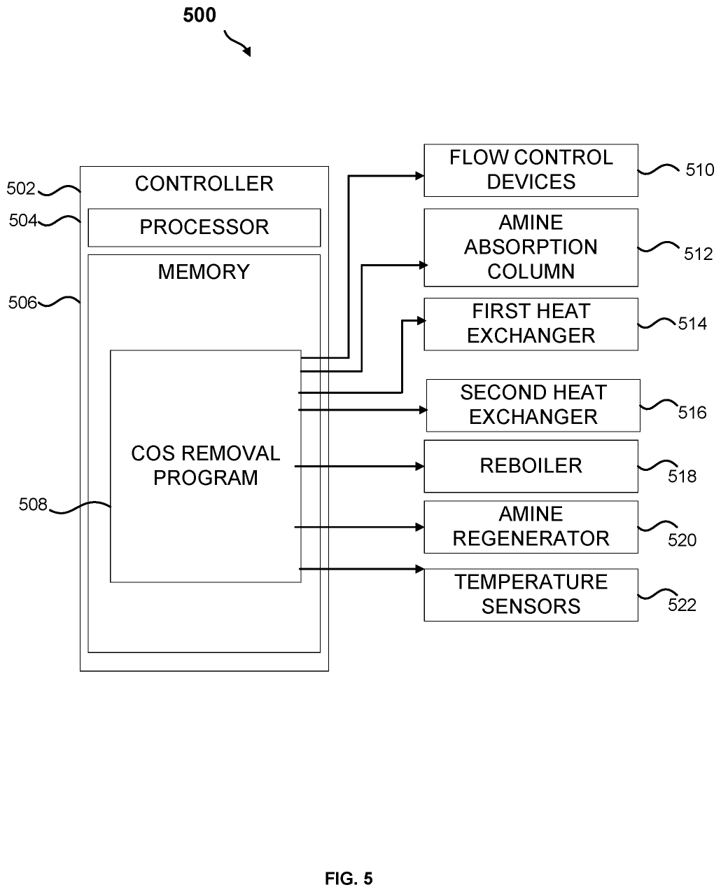

In some embodiments, a flow control device may be positioned along the pipe or pipeline to supply the amine-lean aqueous solution at Input 4. The flow control device may control (for example, limit, increase, decrease, prevent, or allow) a flow rate of the amine-lean aqueous solution at Input 4 flowing into the amine absorption column 102. The flow control device may be a pump, a valve, a flow regulation device, or some combination thereof. In another embodiment, the flow control device may be controlled by a controller or control system (for example, as depicted in FIGS. 4 and 5). In other words, a controller may transmit instructions or signals indicating a particular flow rate to the flow control device and the flow control device may adjust the flow rate based on the received instructions or signals.

The amine absorption column 102 includes packing or two or more trays to facilitate absorption of the fractions of the H₂S and the CO₂ at a first selected temperature range and a first selected pressure range to produce a sweet gas stream at Output 1 that includes the fractions of the CO. Also produced is an amine-rich aqueous solution at Output 2 that includes the thermal labile salts produced based on the interaction between one or more of the fractions of the two or more contaminants and the amine-lean aqueous solution. In some embodiments, the amine-rich aqueous solution including the thermal labile salts produced based on the interaction between the two or more contaminants and the amine-lean aqueous solution may be characterized by a total CO concentration that is substantially undetectable.

In some embodiments, the first selected temperature range is from about 95° F. to about 150° F. and the first selected pressure range is from about 5 atm to about 20 atm. In some embodiments, the sweet gas stream may comprise hydrogen and carbon monoxide. In some embodiments, at least a fraction of the sweet gas stream may comprise hydrogen that is suitable for use as hydrogen plant feed. In some embodiments, the sweet gas stream may be characterized by a total sulfur concentration that is substantially undetectable. The sweet gas stream is supplied to a hydrogen plant.

The packing or two or more trays may be distributed from the upper portion to the lower portion of the amine absorption column 102. The height of the amine absorption column may be dependent on the spacing of the two or more trays. The two or more trays may be fixed inside the column or adjustable. The two or more trays may be evenly spaced apart. The spacing for the two or more trays may vary from about 18 inches to about 24 inches. The amount of packing may depend on the size of the amine absorption column. The selection of an internal mass transfer device such as the packing or the two or more trays may depend on an amount of sweet gas and/or other products to be produced, as will be understood by those skilled in the art.

System 100 also includes a first heat exchanger 104 positioned to receive the amine-rich aqueous solution at Output 2 from the amine absorption column 102. The first heat exchanger 104 heating the amine-rich aqueous solution at Output 2 produces a heated amine-rich aqueous solution at Output 3. The first heat exchanger 104 may be a shell and tube exchanger, a plate exchanger, or a combination thereof. The heat exchanger 104 may have counter-current flow, co-current flow, cross flow, hybrid flow, or a combination thereof.

System 100 further includes an amine regenerator 106 positioned to receive the heated amine-rich aqueous solution at Output 3 from the first heat exchanger 104, as will be understood by those skilled in the art. In the embodiments, the amine regenerator 106 may include packing or two or more trays to separate the fractions of the H₂S and CO₂ from the amine-rich aqueous solution at a second selected temperature range and a second selected pressure range to produce a fluid stream that includes the amine-lean aqueous solution and an acid gas stream that includes the fractions of the H₂S and the CO₂. In some embodiments, the second selected temperature range is from about 225° F. to about 275° F. and the second selected pressure range is from about 1 PSIG to about 15 PSIG.

The first heat exchanger 104 may cause or facilitate heat transfer between the amine-rich aqueous solution at Output 2 and the amine-lean aqueous solution at Input 3 from the amine regenerator 106 by crossflowing the amine-rich aqueous solution at Output 2 in the first heat exchanger 104 with the amine-lean aqueous solution at Input 3. The amine-lean aqueous solution at Input 3 may be heated prior to the heat transfer between the amine-rich aqueous solution at Output 2 and the amine-lean aqueous solution at Input 3. As such, a heated amine-rich aqueous solution at Output 3 may be produced.

The shell and tube heat exchangers may be helical coil heat exchanger, a double pipe heat exchanger, or a combination thereof. The shell and tube exchanger may contain a selected amount of tubes to heat the amine-rich aqueous solution from the amine absorption column 102. The tubes may be single tubes or series of parallel tubes (i.e., tube bundles). The tubes may contain the amine-rich aqueous solution at Output 2. The shell-side may carry the amine-lean aqueous solution at Input 3. The shell and tube exchanger may beat the amine-rich aqueous solution at Output 2 to a selected temperature range. In some embodiments, the selected temperature range may be from about 100 degrees Fahrenheit to about 300 degrees Fahrenheit.

The plate exchanger may be a plate and frame heat exchanger, a plate and shell heat exchanger, or a spiral plate heat exchanger. The plate and frame exchanger may have plate fins or spacers between the plates. The plate and frame exchanger may allow for multiple flow configurations. The plate and frame heat exchanger may beat the amine-rich aqueous solution at Output 2 to a selected temperature range. In some embodiments, the selected temperature range may be from about 100 degrees Fahrenheit to about 300 degrees Fahrenheit

One or more temperature sensors may be positioned along Output 3 to measure the temperature of the heated amine-rich aqueous solution at Output 3. The one or more temperature sensors may be controlled by a control system. The temperature sensors may provide a signal or transmit instructions to the controller based on the temperature at Output 3 provided to the controller. In response to the temperature in Output 3, the control system or controller may direct a temperature adjustment of the heat exchanger 104. The temperature adjustment may increase or decrease the temperature of the heat exchanger 104.

One or more flow control devices may be positioned along Output 3. The flow control device may control (for example, limit, increase, decrease, prevent, or allow) a flow rate of the amine-rich aqueous solution at Output 3 flowing into an amine regenerator 106. The flow control device may be a pump, a valve, a flow regulation device, or some combination thereof. In another embodiment, the flow control device may be controlled by a controller or control system (for example, as depicted in FIGS. 4 and 5). In other words, a controller may transmit instructions or signals indicating a particular flow rate to the flow control device and the flow control device may adjust the flow rate based on the received instructions or signals.

The amine regenerator 106 may be known as a stripper column. The amine regenerator 106 may reduce the fractions of the H₂S and CO₂ from the amine-rich aqueous solution at a second selected temperature range and a second selected pressure range. The fluid stream that includes the amine-lean aqueous solution may be produced from the bottom portion of the amine regenerator 106 at Output 4 and the acid gas stream that includes the fractions of the H₂S and the CO₂ may be produced at Output 5 from an upper portion of the amine regenerator. In some embodiments, the acid gas stream includes H₂S and CO₂.

Packing or two or more trays may be distributed from an upper portion to a lower portion of the amine regenerator. The height of the amine regenerator may be dependent on the spacing of the two or more trays. The two or more trays may be fixed inside the amine regenerator or adjustable. The two or more trays may be evenly spaced apart. In some embodiments, the spacing for the two or more trays may vary from about 18 inches to about 24 inches. The amount of packing may depend on the size of the amine regenerator. The selection of an internal mass transfer device such as the packing or the two or more trays may depend on an amount of product to be produced and/or an amount of gas to process, as will be understood by those skilled in the art. The amine-rich aqueous solution may pass over the mass transfer device thereby separating the fractions of the H₂S and the CO₂ from the amine-rich aqueous solution. In some embodiments, one or more of an oxidant, steam, water vapor and combinations thereof may be supplied to the amine regenerator to treat the amine-rich aqueous solution.

The fluid stream that includes the amine-lean aqueous solution at Output 4 may be recycled to the amine absorption column 102. As such, system 100 may further include a reboiler 108 positioned to receive the fluid stream that includes the amine-lean aqueous solution at Output 4 from the amine regenerator 106. The reboiler may be capable of heating the fluid stream that includes the amine-lean aqueous solution at Output 4 to output a heated amine-lean aqueous solution at Input 3 thereby to cross-exchange heat with the amine-rich aqueous solution at Output 2 at the first heat exchanger 104. In the embodiments, the reboiler may operate at a temperature from about 200 degrees Fahrenheit to about 300 degrees Fahrenheit. In some embodiments, the reboiler 108 may supply one or more of an oxidant, steam, water vapor and combinations thereof at Input 2 to the amine regenerator 106 to treat the amine-rich aqueous solution. The one or more of an oxidant, steam, water vapor and combinations thereof may enter the mass transfer device.

The heated amine-lean aqueous solution at Input 3 may assist in separating the fractions of the H₂S and the CO₂ from the amine-rich aqueous solution in the amine regenerator 106 when used to heat the amine-rich aqueous solution at the heat exchanger 104. The heated amine-lean aqueous solution at Input 3 may cross-exchange heat with the amine-rich aqueous solution at Output 2 at the first heat exchanger 104 prior to recycling to the amine absorption column 102 as amine-lean aqueous solution at Input 4.

The heated amine-lean aqueous solution at Input 4 may have a flow control device. The flow control device may be a pump, a valve, or a flow regulation device. In another embodiment, the flow control device may be controlled by a control system. The flow control device may provide a signal or transmit instructions to the controller based on the flowrate at Input 4 provided to the controller. Additionally, flow control device may provide a signal or transmit instructions to the controller based on the performance of the amine-lean aqueous solution inside the Amine Absorption Column 102. In response to the flowrate at Input 4, the control system or controller may direct a flowrate adjustment of the heat exchanger 104. The flowrate adjustment may increase or decrease the flowrate of the amine-lean aqueous solution at Input 4.

In some embodiments, the system 100 may further include a second heat exchanger 104 positioned to receive the heated amine-lean aqueous solution at Input 3 from the first heat exchanger 104. The second heat exchanger 104 may be capable of cooling the heated amine-lean aqueous solution from Input 3 to output the amine-lean aqueous solution at Input 4 at a third selected temperature range to supply the portion of the amine absorption column with the amine-lean aqueous solution. In some embodiments, the third selected temperature range is from about 25° F. to about 50° F. above the temperature of the gas stream that includes the fractions of the two or more contaminants supplied to the amine absorption column.

System 100 also includes a metal oxide adsorbent vessel 110 positioned to receive the fractions the H₂S and CO₂ at Output 5, for example, as will be understood by those skilled in the art. The metal oxide adsorbent vessel 110 absorbs the fractions of the H₂S to produce an effluent stream that includes CO₂. In some embodiments, the metal oxide adsorbent vessel may contain a metal oxide adsorbent material comprising copper oxide or iron oxide. In other embodiments, the metal oxide adsorbent material may be magnesium oxide or zinc oxide.

System 100 further includes downstream equipment 112 positioned to receive and further use and/or process the CO₂ from the metal oxide adsorbent vessel 110 in Output 6. In some embodiments, the downstream equipment 112 may comprise a combustion device such as a flare, a thermal oxidizer, and a fuel header. In some embodiments, the downstream equipment 112 may be configured to capture and sequester the CO₂ and/or capture the CO₂ for further use and/or processing. For example, the downstream equipment 112 may capture and purify the CO₂ such that the CO₂ may be utilized in food and beverage products. In another non-limiting example, the downstream equipment 112 may capture and transfer and/or transport the CO₂ for injection into a well and/or to be mixed with cement.

In some embodiments, the amine absorption column 102, the amine regenerator 106, and the metal oxide adsorbent vessel 110 are operated continuously. In other embodiments the amine absorption column 102, the amine regenerator 106, and the metal oxide adsorbent vessel 110 are operated interment.

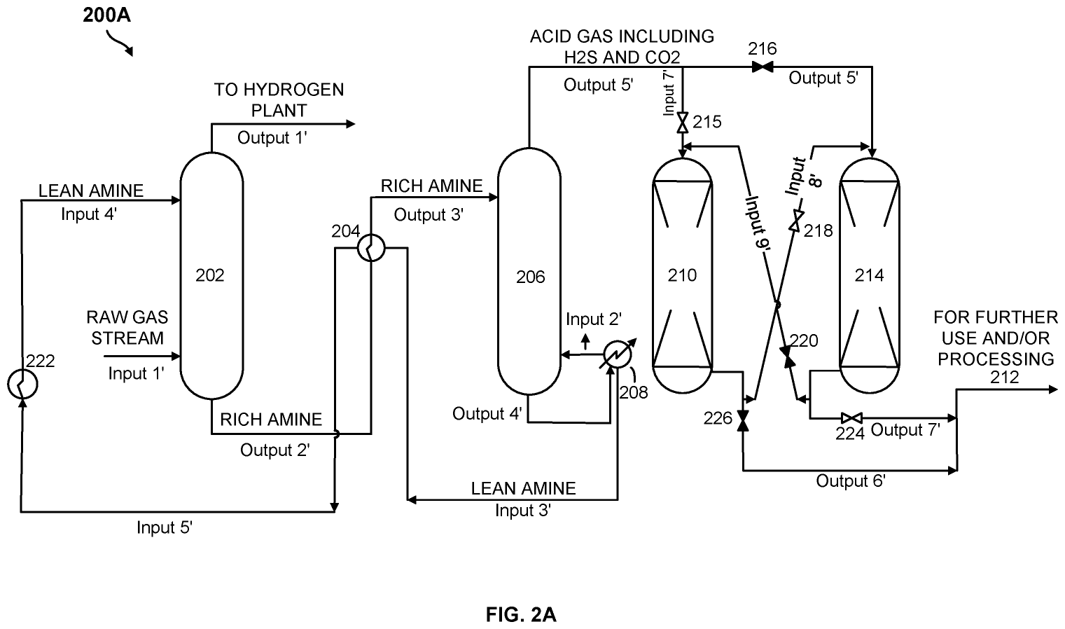

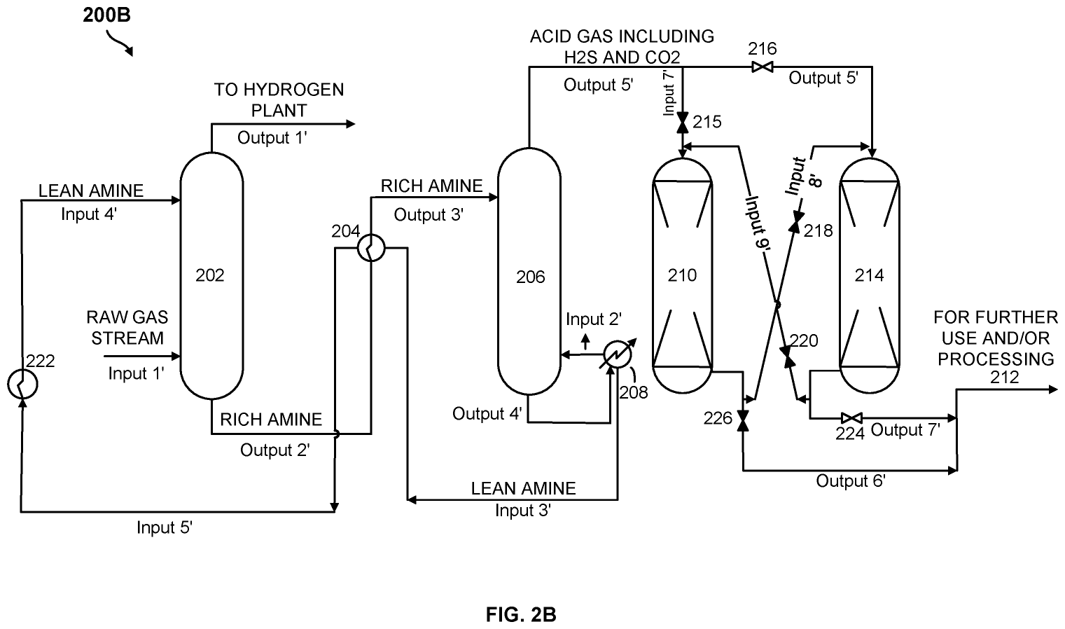

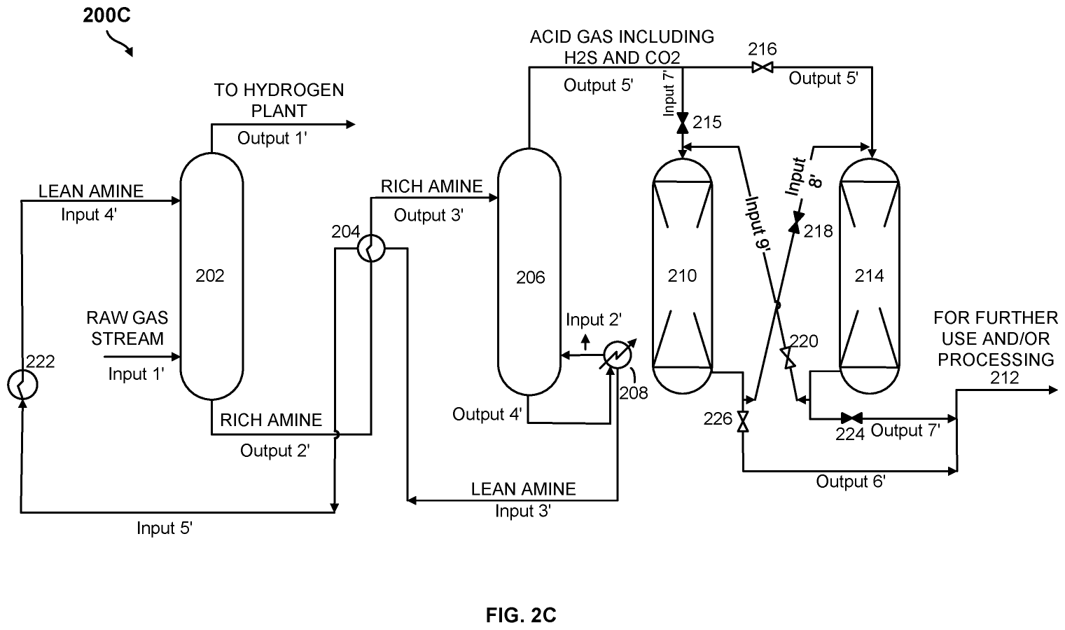

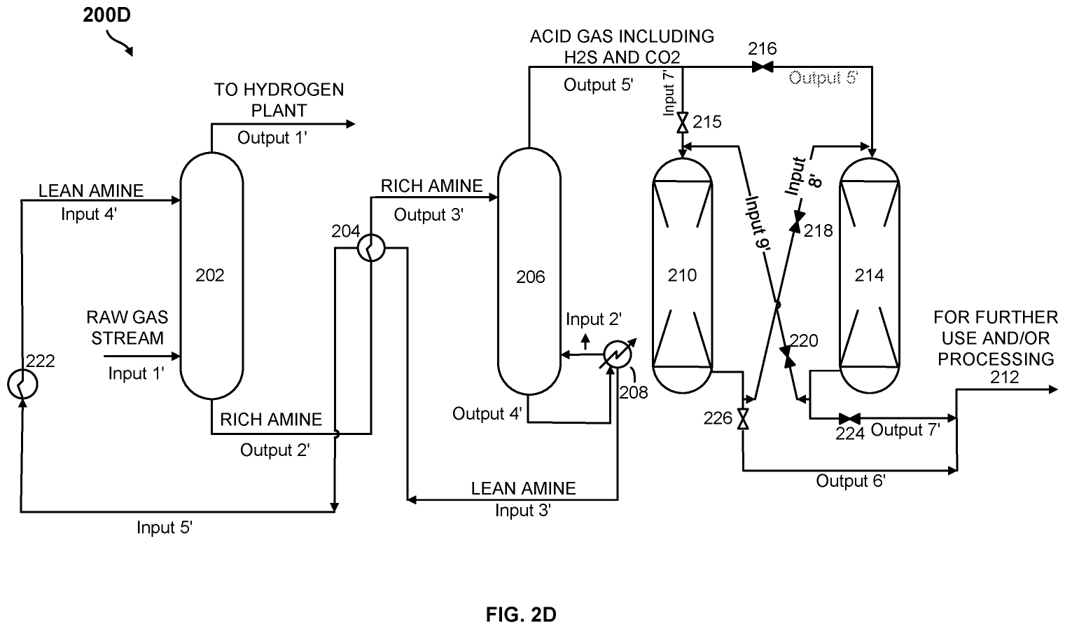

According to an embodiment of the present disclosure, system 200A in FIG. 2A is present as similarly described in FIG. 1 In the embodiment, the amine absorption column 202, the first heat exchanger 204, the second heat exchanger 222, the amine regenerator 206, and the reboiler 208 function as described in FIG. 1. System 200A, however, further includes an additional metal oxide adsorbent vessel 214. For illustrative purposes, the additional metal oxide adsorbent vessel 214 in FIG. 2A, may be known as a lag metal oxide adsorbent vessel 214. The lag metal oxide adsorbent vessel 214 may be used for alternating between the lead metal oxide adsorbent vessel 210 or, in another embodiment, to polish or remove any remaining H₂S fraction from effluent from the lead metal oxide adsorbent vessel 210. The lead metal oxide adsorbent vessel 210 and the lag metal oxide adsorbent vessel 214 may be run in series flowing from the lead metal oxide adsorbent vessel 210 to the lag metal oxide adsorbent vessel 214 or individually, for instance, when lead metal oxide adsorbent vessel 210 is down for maintenance, as shown in FIG. 2B. In some embodiments, the lead metal oxide adsorbent vessel 210 is positioned to receive the fractions of H₂S and CO₂ in Output 5′. In another embodiment, the lead and lag designation for either metal oxide adsorbent vessel may be determined based on which metal oxide adsorbent vessel receives effluent from the amine regenerator 206 first.

The system further includes valves 215, 216, 218, 220, 224, and 226 for enabling the flow of the acid gas stream in Output 5′ to the lead metal oxide adsorbent vessel 210 or the lag metal oxide adsorbent vessel 214, based on which is the current lead (in other words, based on which metal oxide adsorbent vessel receives the acid gas stream first as determined by previous maintenance).

The lead metal oxide adsorbent vessel 210 and the lag metal oxide adsorbent vessel 214, each include the metal oxide adsorbent material for adsorbing the H₂S fraction to produce an effluent stream that includes CO₂. The metal oxide adsorbent material may be copper oxide, iron oxide, magnesium oxide, or zinc oxide.

System 200A further includes the lead metal oxide adsorbent vessel 210 and the lag metal oxide adsorbent vessel 214 in series. Valve 216 is closed to block flow of the acid gas stream in Output 5′ from the amine regenerator 206 to the lag metal oxide adsorbent vessel 214. Valve 215 is open to allow flow to the lead metal oxide adsorbent vessel 210. The acid gas including H₂S and CO₂ flows downward through the lead metal oxide adsorbent vessel 210. The lead metal oxide adsorbent vessel 210 serves as a bulk removal for the H₂S fractions. Valve 218 is open to allow the acid gas including the remaining H₂S and CO₂ to flow to the lag metal oxide adsorbent vessel 214. The lag metal oxide adsorbent vessel 214 serves as a polisher to remove any remaining H₂S fractions. The acid gas including H₂S and CO₂ flows downward through the lag metal oxide adsorbent vessel 214. Valve 224 on Output 7′ is open to allow the effluent stream that includes CO₂ to the downstream equipment 212 for further use and/or processing.

According to an embodiment of the present disclosure, system 200B in FIG. 2B is present as similarly described in FIG. 2A In some embodiments, the lag metal oxide adsorbent vessel 214 operates independent of the lead metal oxide adsorbent vessel 210 when the lead metal oxide adsorbent vessel 210 is not in service, such as during maintenance operation as illustrated in FIG. 2B. Valve 215 is closed to block flow of the acid gas stream that includes the fractions of the H₂S and CO₂ in Output 5′ to the lead metal oxide adsorbent vessel 210. Valve 216 is open to allow flow to the lag metal oxide adsorbent vessel 214. During maintenance operations such as cleaning, the metal oxide adsorbent material in the lead metal oxide adsorbent vessel 210 may be replaced with new metal oxide adsorbent material. In other embodiments, the metal oxide adsorbent material may be removed from the lead metal oxide adsorbent vessel 210 and replaced with a different metal oxide adsorbent material. Valve 224 on Output 7′ is open to allow the effluent stream that includes CO₂ to the downstream equipment 212 for further use and/or processing.

According to an embodiment of the present disclosure, system 200C in FIG. 2C is present as similarly described in FIG. 2A and FIG. 2B. In the embodiment, the amine absorption column 202, the first heat exchanger 204, the second heat exchanger 222, the amine regenerator 206, and the reboiler 208 function as previously described. System 200C, however, the lag metal oxide adsorbent vessel 214 serves as a bulk removal of the H₂S and the lead metal oxide adsorbent vessel 210 serves as the polisher (such as to remove any remaining or a portion of any remaining H₂S fractions). The lag metal oxide adsorbent vessel 214 may be used for alternating between the lead metal oxide adsorbent vessel 210. The lag metal oxide adsorbent vessel 214 and the lead metal oxide adsorbent vessel 210 may be run in series flowing from the lag metal oxide adsorbent vessel 214 to the lead metal oxide adsorbent vessel 210 or individually, for instance, when lag metal oxide adsorbent vessel 214 is down for maintenance, as shown in FIG. 2D. In some embodiments, the lag metal oxide adsorbent vessel 214 is positioned to receive the fractions of H₂S and CO₂ in Output 5′.

System 200C further includes the lag metal oxide adsorbent vessel 214 and the lead metal oxide adsorbent vessel 210 in series. Valve 215 is closed to block flow of the acid gas stream that includes the fractions of the H₂S and CO₂ in Output 5′ to the lead metal oxide adsorbent vessel 210. Valve 216 is open to allow flow to the lag metal oxide adsorbent vessel 214. The acid gas including H₂S and CO₂ flows downward through the lag metal oxide adsorbent vessel 214. The lag metal oxide adsorbent vessel 214 serves as a bulk removal for the H₂S fractions. Valve 220 is open to allow the acid gas including the remaining H₂S and CO₂ to flow to the lead metal oxide adsorbent vessel 210. The lead metal oxide adsorbent vessel 210 serves as a polisher to remove any remaining H₂S fractions. The acid gas including H₂S and CO₂ flows downward through the lead metal oxide adsorbent vessel 210. Valve 226 on Output 6′ is open to allow the effluent stream that includes CO₂ to the downstream equipment 212 for further use and/or processing.

According to an embodiment of the present disclosure, system 200D in FIG. 2D is present as similarly described in FIG. 2C In some embodiments, the lead metal oxide adsorbent vessel 210 operates independent of the lag metal oxide adsorbent vessel 214 when the lag metal oxide adsorbent vessel 214 is not in service, such as during maintenance operation as illustrated in FIG. 2D. Valve 216 is closed to block flow of the acid gas stream that includes the fractions of the H₂S and CO₂ in Output 5′ to the lag metal oxide adsorbent vessel 214. Valve 215 is open to allow flow to the lead metal oxide adsorbent vessel 210. During maintenance operations such as cleaning, the metal oxide adsorbent material in the lag metal oxide adsorbent vessel 214 may be replaced with new metal oxide adsorbent material. In other embodiments, the metal oxide adsorbent material may be removed from the lag metal oxide adsorbent vessel 214 and replaced with a different metal oxide adsorbent material. Valve 226 on Output 6′ is open to allow the effluent stream that includes CO₂ to the downstream equipment 212 for further use and/or processing.

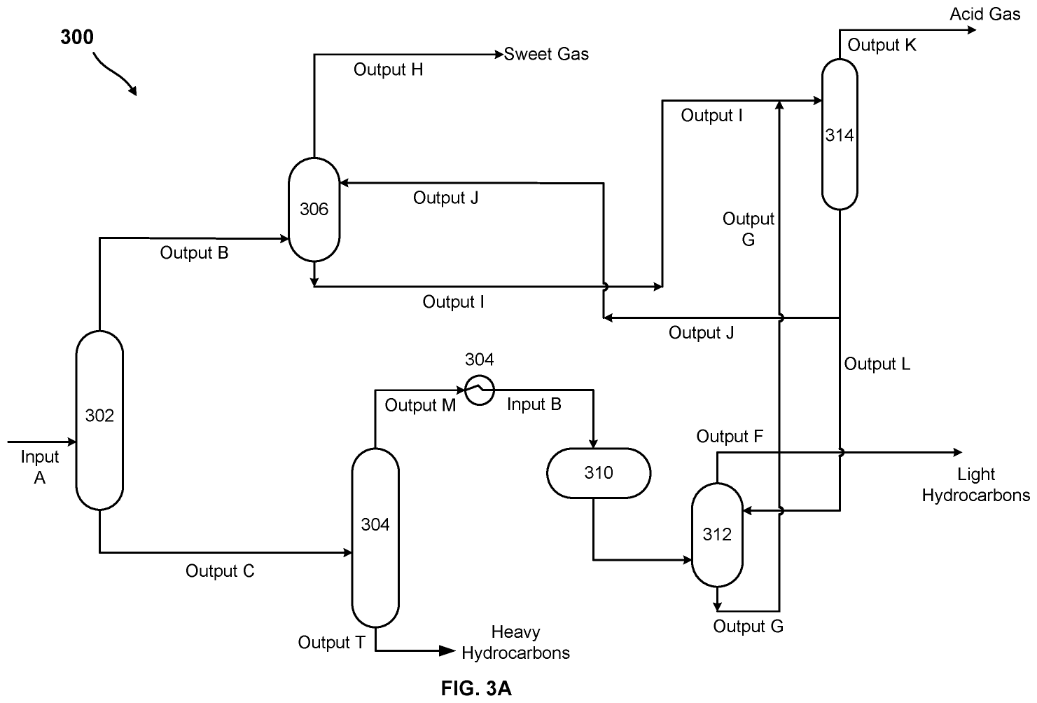

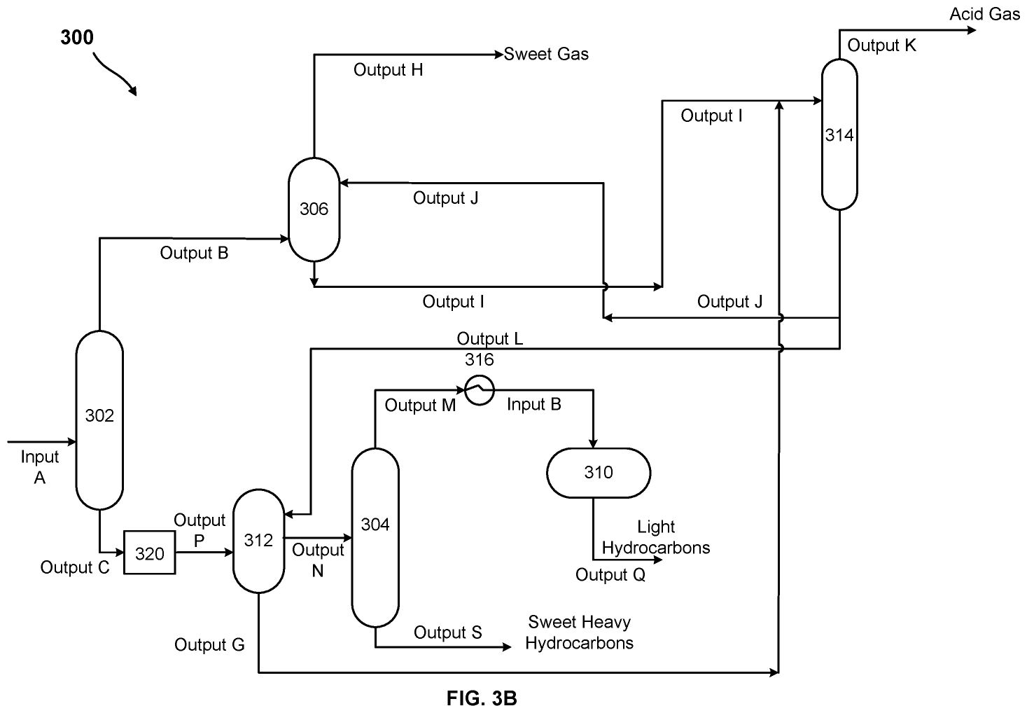

FIG. 3A is a schematic diagram illustration of a system for the separation of light hydrocarbons from heavier hydrocarbon to prevent formation of COS in the production of sweet gas and light hydrocarbons, according to an embodiment of the disclosure. A mixed fluid stream that includes fractions of CO, fractions of two or more contaminants including H₂S and CO₂, and hydrocarbons in Input A is introduced into a deethanizer 302. The deethanizer 302 may be referred to as a separation device, a light hydrocarbon fractionator, a stripper, a fractionator, or other terms known to those skilled in the art. The deethanizer 302 separate the raw gas at Output B from the light hydrocarbons and the heavy hydrocarbons at Output C. Output B is the raw gas stream as described herein. The vapor phase absorber 306 has packing or two or more trays and the amine-lean aqueous solution. The amine-lean aqueous solution is introduced into the vapor phase absorber 306, also known as the amine absorption column in Output J. The vapor phase absorber 306 function as previously described in the description of the amine absorption column.

The amine-lean aqueous solution in system 300A is a closed loop system. The amine-lean aqueous solution absorbs the H₂S fraction and CO₂ fraction from the raw gas stream. In the vapor phase absorber 306, the amine-lean aqueous solution absorbs the fractions of the H₂S and CO₂ in the raw gas stream to produce two streams, a sweet gas stream that includes the fractions of the CO in Output H and an amine-rich aqueous solution that includes the thermal labile salts produced based on the interaction between one or more of the fractions of the two or more contaminants and the amine-lean aqueous solution in Output I. As previously described, the amine-rich aqueous solution is regenerated in the new regen column 314 also known as the amine regenerator, to produce the amine-lean aqueous solution in Output J and Output L. In the new regen column 314, the fractions of the H₂S and CO₂ from the amine-rich aqueous solution may be reduced to produce a fluid stream that includes the amine-lean aqueous solution that may be recycled to the vapor phase absorber 306 and to a liquid phase absorber 312. The new regen column 314 also produce an acid gas stream that includes fractions of the H₂S and CO₂ in Output K where the acid gas will further be processed in the metal oxide adsorbent vessel as described herein to adsorb the H₂S.

The light hydrocarbons and the heavy hydrocarbons including the CO and the fractions of H₂S and CO₂ is fed into the depropanizer 304 where propane is isolated from the heavy hydrocarbons. The propane stream including the fractions of H₂S and CO₂ is further processed in a heat exchanger 316 and a flash drum 310 prior to the liquid phase absorber 312. The heavy hydrocarbons at Output T may be further processed downstream. In the embodiment, the heavy hydrocarbons may include Naphtha. The amine-lean aqueous solution from the new regen column 314 may enter the liquid phase absorber 312 from Output L where the fractions of H₂S and CO₂ may be absorbed in the amine-lean aqueous solution to produce two streams. The liquid phase absorber 312 produce the amine-rich aqueous solution in Output G and a light hydrocarbons stream that includes CO in Output F. The amine-rich aqueous solution in Output G mix with the amine-rich aqueous solution in Output I prior to regeneration in the new regen column 314 as described herein.

FIG. 3B is a schematic diagram illustration of a system for the separation of light hydrocarbons from heavier hydrocarbon to prevent formation of COS in the production of sweet gas and light hydrocarbons, according to an embodiment of the disclosure. A mixed fluid stream that includes fractions of CO, fractions of two or more contaminants including H₂S and CO₂, and hydrocarbons in Input A is introduced into a deethanizer 302. The deethanizer 302 separate the raw gas at Output B from the light hydrocarbons and heavy hydrocarbons at Output C as described in FIG. 3A. The amine-lean aqueous solution is introduced into the vapor phase absorber 306, also known as the amine absorption column in Output J. The vapor phase absorber 306 function as described in FIG. 3A.

The amine-lean aqueous solution in system 300B is a closed loop system. The amine-lean aqueous solution absorbs the H₂S fraction and CO₂ fraction from the raw gas stream. In the vapor phase absorber 306, the amine-lean aqueous solution absorbs the fractions of the H₂S and CO₂ in the light hydrocarbons to produce two streams, a sweet gas stream that includes the fractions of the CO in Output H and an amine-rich aqueous solution that includes the thermal labile salts produced based on the interaction between one or more of the fractions of the two or more contaminants and the amine-lean aqueous solution in Output I. As previously described, the amine-rich aqueous solution is regenerated in the new regen column 314 also known as the amine regenerator, to produce the amine-lean aqueous solution in Output J and Output L. In the new regen column 314, the fractions of the H₂S and CO₂ from the amine-rich aqueous solution may be reduced to produce a fluid stream that includes the amine-lean aqueous solution that may be recycled to the vapor phase absorber 306 and to a liquid phase absorber 312. The new regen column 314 also produce an acid gas stream that includes fractions of the H₂S and CO₂ in Output K where the acid gas will further be processed in the metal oxide adsorbent vessel as described herein to adsorb the H₂S.

The light hydrocarbons and heavy hydrocarbons including the CO and the fractions of H₂S and CO₂ from the deethanizer 302 in Output C are directed to a cooler 320 to cool the heavier hydrocarbons before mixing with the amine-lean aqueous solution at the liquid phase absorber 312. In an embodiment, the cooler 320 may include a heat exchanger or a heat sink. The light hydrocarbons and heavy hydrocarbons are cooled to prevent, for example, boil off of the amine-lean aqueous solution. The cooled light hydrocarbons and heavy hydrocarbons in Output P are directed from the cooler 320 to the liquid phase absorber 312. The amine-lean aqueous solution is directed from the new regen column 314 in Output L to the liquid phase absorber 312 to absorb the fractions of H₂S and CO₂ in the light hydrocarbons and heavy hydrocarbons. Two streams are produced. The liquid phase absorber 312 produce the amine-rich aqueous solution in Output G containing the H₂S and CO₂ and the heavier hydrocarbons that includes CO in Output N. The amine-rich aqueous solution is directed from the liquid phase absorber 312 in Output G to mix with the amine-rich aqueous solution in Output I prior to regeneration in the new regen column 314 as described herein.

The light and heavy hydrocarbons that includes CO in Output N are directed to the depropanizer 304 where light hydrocarbons (such as propane) is isolated from other heavier hydrocarbons. The light hydrocarbon stream (such as a propane stream) in Output M is directed to a heat exchanger 316. The heated propane in Input B from the heat exchanger 316 is directed to a flash drum 310 to produce a light hydrocarbons stream that includes CO in Output Q. The sweet heavy hydrocarbons at Output S may be further processed downstream.

FIG. 4 is a simplified diagram that illustrates system 400 with a controller 418. The controller 418, in response to one or more signals, measurements, or operating conditions (such as temperature, pressure, and/or other characteristics), may determine the operability of various equipment within the system. For example, the controller 418 may include a processor, a memory, and a COS program. In response to one or more signals, measurements, or operating conditions (such as temperature, pressure, and/or other characteristics as indicated by various sensors positioned throughout the system), the COS program may determine the operability of flow control devices, amine absorption column, first heat exchanger, second heat exchanger, reboiler, amine regenerator, and other equipment within the system. The controller 418 may adjust the flow of the amine-lean aqueous solution into the amine absorption column 402 based on a signal indicating a flow rate received from the flow control device 412 as compared to, for example, a flow rate threshold range. The flow control device may include a pump, a valve, and/or other equipment to control flow. The flow control device may provide a signal, indicator, or measurement to the controller 418 and, based on that signal, indicator, or measurement the controller 418 may increase or decrease the flow of amine to the amine absorption column 402.

The sweet gas stream to the hydrogen plant, may also flow through a flow control device 414 positioned in the system. The flow control device 414 may provide a signal. Indicator, or measurement to the controller 418 and, based on the signal. Indicator, or measurement, the controller 418 may start or stop the flow of sweet gas stream from the amine absorption column. In some embodiments, the controller 418 may receive a signal, indicator, or measurement from the amine absorption column 402 (for example, sensors or other measurement devices positioned therein, thereon, or in proximity) and, based on the signal, indicator, or measurement, may increase or decrease the amount of raw gas supplied to the amine absorption column 402 or adjust the amount of amine-lean aqueous solution supplied to the amine absorption column 402.

The controller 418 may receive a signal, indicator, or measurement from the heat exchanger 404 (for example, temperature sensor 416) and based on the signal, indicator, or measurement to adjust the temperature of the first heat exchanger 404. In other embodiments, the controller 418 may control the operability of the amine regenerator 406. The controller 418 may also receive a signal from the reboiler 408 to adjust the temperature of the heated amine-lean aqueous solution. The controller 418 may also adjust the amount of the one or more of an oxidant, steam, water vapor and combinations thereof that may mix with the amine-rich aqueous solution in the amine regenerator 406 (for example, via a flow control device). The controller 418 may further be in signal communication with the metal oxide adsorbent vessel 410A and the metal oxide adsorbent vessel 410B (for example, sensors or other measurement devices positioned therein, thereon, or in proximity). The controller 418 may be in signal communication with valves and/or other flow control devices to control the flow to metal oxide adsorbent vessel A and metal oxide adsorbent vessel B. In other embodiments, the controller 418 may be in signal communication with a flow control device 430 to control the flow of the effluent stream to the downstream equipment for further use and/or processing.

FIG. 5 is a simplified diagram, implemented in a controller, for controlling system 500, according to an embodiment of the present disclosure. As noted, systems 100, 200, 300 may include a controller 502 as described herein. The controller 502 may connect to the temperature sensors, pressure sensors, flow control devices, or other electronic devices positioned at various points in the system.

The controller 502 may include memory 506 and one or more processors 504. The memory 506 may store instructions executable by the one or more processors 504. In an example, the memory 506 may be a non-transitory machine-readable storage medium. As used herein, a “machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (for example, hard drive), a solid state drive, any type of storage disc, and the like, or a combination thereof. As noted, the memory 506 may store or include instructions executable by the processor 504. As used herein, a “processor” may include, for example one processor or multiple processors included in a single device or distributed across multiple computing devices. The processor 504 may be at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof

As used herein, “signal communication” refers to electric communication such as hard wiring two components together or wireless communication, as understood by those skilled in the art. For example, wireless communication may be Wi-Fi®, Bluetooth®, ZigBee, or forms of near field communications. In addition, signal communication may include one or more intermediate controllers or relays disposed between elements that are in signal communication with one another. In an embodiment, the controller 502 may include a plurality of inputs, outputs, and/or input/outputs. The controller 502 may connect to the various components or devices described herein via the plurality of inputs, outputs, and/or input/outputs.

As noted, the memory 506 may include instructions. The instructions may include COS removal program instructions 508 to prevent the formation of COS based on one or more inputs. The controller 502 may receive the inputs and based on those inputs to initiate the process to prevent the formation of COS. The inputs may include flow control devices 510, the first heat exchanger 514, the second heat exchanger 516, the reboiler 518, and temperature sensors 522. Signals, indicators, and/or measurements corresponding to the inputs may be gathered from various locations in the system as previously described in FIG. 1, FIG. 2A, and FIG. 2B. In some embodiments, one or more of the inputs may correspond to the amine absorption column 512 and the amine regenerator 520 and may provide one or more measurements of flow, pressure, and temperature to the controller 502. Based on the received measurements, the controller 502 may execute the instructions to control flow to and/or from the amine absorption column 512 and the amine regenerator 520 and/or temperature within the amine absorption column 512 and the amine regenerator 520.

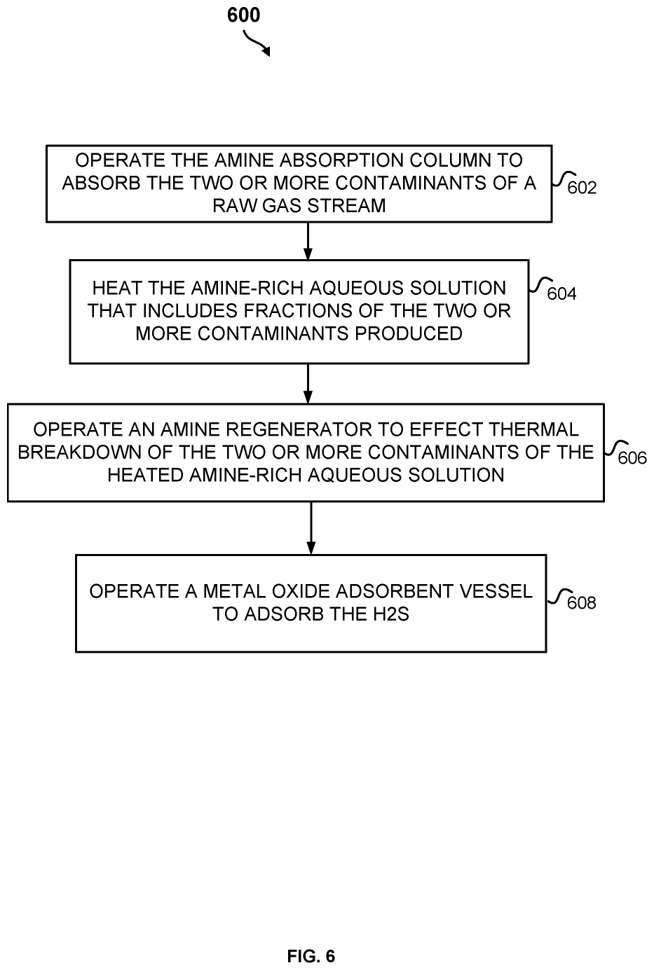

FIG. 6 is a simplified block diagram directed to a method 600 of preventing formation of carbonyl sulfide (COS) in the production of sweet gas. For purposes of illustration, an embodiment of a method 600 depicted in FIG. 6 may be implemented using system 100, 200A, 200B preventing formation of carbonyl sulfide (COS) in the production of sweet gas.

Method 600 involves step 602 of operating an amine absorption column at a first selected temperature range and a first selected pressure range so that fractions of two or more contaminants (such as H₂S and CO₂) of a raw gas stream are absorbed in an amine-lean aqueous solution. The raw gas stream and amine-lean aqueous solution is as previously described in the present disclosure.

A sweet gas stream that includes fractions of CO for supply to a hydrogen facility and an amine-rich aqueous solution that includes fractions of the two or more contaminants may be produced. The two or more contaminants may include H₂S and CO₂. The interaction between the amine-lean aqueous solution and one or more of the fractions of the two or more contaminants (such as H₂S and CO₂) generates or produces thermal labile salts. The amine-rich aqueous solution may include the generated or produced thermal labile salts.

The method 600 further involves the step 604 of heating the amine-rich aqueous solution to output a heated amine-rich aqueous solution that includes the fractions of the two or more contaminants. Heating the amine rich aqueous solution may include using a first heat exchanger to produce a heated amine-rich aqueous solution for supply to the amine regenerator. Various types of heat exchangers may be used as previously described.

The method 600 also involves the step 606 of operating an amine regenerator at a second selected temperature range and a second selected pressure range, such as to effect thermal breakdown of the two or more contaminants of the heated amine-rich aqueous solution. An acid gas stream that includes the two or more contaminants and the amine-lean aqueous solution may be produced. The first selected temperature range may be from about 95 degrees Fahrenheit to about 150 degrees Fahrenheit and the first selected pressure range may be from about 5 standard atm of absolute pressure of 20 atm of absolute pressure. In addition, the second selected temperature range may be from about 225 degrees Fahrenheit to about 275 degrees Fahrenheit and the first selected pressure range may be from about 1 PSIG to about 15 PSIG.

In some embodiments, the method 600 further may include the step of supplying the amine-lean aqueous solution to a reboiler capable of heating the amine-lean aqueous solution to produce a heated amine-lean aqueous solution. The method 600 may further include supplying the heated amine-lean aqueous solution to the first heat exchanger so that the heated amine-lean aqueous solution cross-exchanges heat with the amine-rich aqueous solution to output the heated amine-rich aqueous solution. The method 600 may also include the step of recycling the heated amine-lean aqueous solution to a second heat exchanger capable of cooling the heated amine-lean aqueous solution to output the amine-lean aqueous solution at a third selected temperature range to supply to the amine absorption column with the amine-lean aqueous solution capable of adsorbing the fractions of the two or more contaminants. The third selected temperature range may be from about 25 degrees Fahrenheit to about 50 degrees Fahrenheit above a temperature of the raw gas stream that includes the fractions of the two or more contaminants supplied to the amine absorption column.

The method 600 further includes the step 608 of operating a metal oxide adsorbent vessel to adsorb the H₂S of the two or more contaminants in the acid gas stream thereby produce an effluent stream that includes CO₂.

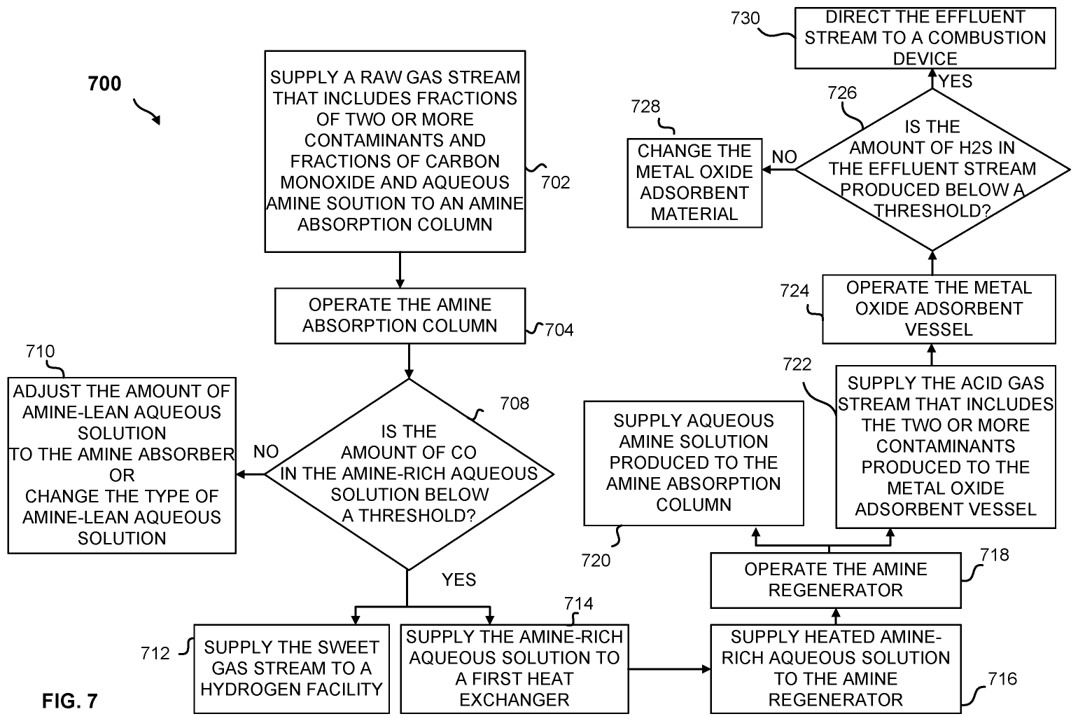

FIG. 7 is a flow diagram of an embodiment of a method for preventing formation of carbonyl sulfide in the production of sweet gas. The method, for example, also is described with reference to system 100 of FIG. 1. The method involves the step 702 of supplying a raw gas stream that includes fractions of two or more contaminants and fractions of CO to an amine absorption column, as will be understood by those skilled in the art. The two or more contaminants, for example, include H₂S and CO₂. Additionally, an amine-lean aqueous solution may be supplied to the amine absorption column. The amine-lean aqueous solution may be capable of absorbing the fractions of the two or more contaminants.

The method further involves the step 704 of operating the amine absorption column at the first selected temperature range and first selected pressure range previously described. The amine-lean aqueous solution may be capable of absorbing the fractions of the two or more contaminants at the first selected temperature and the first selected pressure to produce a sweet gas stream that includes the fractions of the CO and an amine-rich aqueous solution that includes thermal labile salts produced based on interactions between one or more of the fractions of the two or more contaminants and the amine-lean aqueous solution.

In some embodiments, the outlets of the amine absorption column may have one or more analyzers to analyze the concentrations in the amine-rich aqueous solution and the sweet gas stream. The one or more analyzers may be a composition fluid analyzer. The one or more analyzers, may have set specification ranges, setting limits on the composition. In some embodiments, the one or more analyzers may be out of the range.

Method 700 may further involve step 708 where a decision is made whether to continue with the process in preventing the formation of COS or whether to adjust the amine absorption column based on the amount of CO in the amine-rich aqueous solution. If the amount of CO in the amine-rich aqueous solution is determined to be outside of the set specification range, the method 700 also involves the step 710 of adjusting the amount of amine-lean aqueous solution to the amine absorption column or changing the amine-lean aqueous solution may be changed. The amine-lean aqueous solution may include one or more amines selected from the group including monoethanolamine (MEA), diethanolamine (DEA), 2-amino-2-methylpropanol (AMP), methyldiethanolamine (MDEA), piperazine (PIPA) and combinations thereof. The amine-rich aqueous solution that includes the thermal labile salts produced based on the interaction between one or more of fractions of the two or more contaminants and the amine-lean aqueous solution may be characterized by a total CO concentration that is substantially undetectable. In the embodiments, the amount of CO supplied to the hydrogen plant may be measured.

If the amount of CO in the treated stream is determined to be within the set specification range, the method further involves the step 712 of outputting the sweet gas stream that includes the fractions of the CO for supply to a hydrogen facility. The method also involves the step 714 of supplying the amine-rich aqueous solution to a first heat exchanger to produce a heated amine-rich aqueous solution. At the first heat exchanger, the amine-rich aqueous solution may cross-exchange heat with heated amine-lean aqueous solution to produce the heated amine-rich aqueous solution.

The method further involves the step 716 of supplying the heated amine-rich aqueous solution to an amine regenerator, as will be understood by those skilled in the art. The amine regenerator is used to regenerate the amine-rich aqueous solution.

The method further involves the step 718 of operating the amine regenerator at a second selected temperature range and a second selected pressure range to effect thermal breakdown of the thermal labile salts. As such, an acid gas stream that includes the two or more contaminants and the amine-lean aqueous solution may be produced. The heated amine-rich aqueous solution may assist in stripping the H₂S and CO₂ from the amine-rich aqueous solution. In some embodiments, the amine regenerator may include one or more of an oxidant, steam, water vapor and combinations thereof to assist in stripping the H₂S and CO₂ from the amine-rich aqueous solution.

The method 700 also involves the step 720 of supplying the amine-lean aqueous solution to a reboiler capable of heating the amine-lean aqueous solution to produce a heated amine-lean aqueous solution. The reboiler may produce a heated amine-lean aqueous solution. The heated amine-lean aqueous solution may be cross-exchanged with the amine-rich aqueous solution as previously described. The heated amine-lean aqueous solution may then be cooled in a second heat exchanger prior to being used as amine-lean aqueous solution in the amine absorption column.

The method 700 also involves the step 722 of supplying the acid gas stream that includes the two or more contaminants to a metal oxide adsorbent vessel capable of separating the two or more contaminants by adsorption of the H₂S. The metal oxide adsorbent vessel may contain a metal oxide adsorbent material including copper oxide and iron oxide. The method further also involves the step 724 of operating the metal oxide adsorbent vessel to adsorb the H₂S to produce an effluent stream that includes CO₂.

At step 726, a decision on whether the amount of H₂S in the effluent stream is below a threshold is considered. If the amount of H₂S in the effluent steam is not below a threshold, the method 700 further involves the step 728 of changing the metal oxide adsorbent material. If the amount of H₂S in the effluent steam is below a threshold, the method 700 involves the step 730 of directing the effluent stream that includes the CO₂ to downstream equipment for further use and/or processing. The downstream equipment may comprise a combustion device including one or more of a flare, a thermal oxidizer, or a fuel header, or equipment for capturing and sequestering the CO₂. In an embodiment, the combustion device may burn any residual hydrocarbons in the CO₂ and then release the CO₂ into the atmosphere or capture the CO₂.

The present application claims priority to and the benefit of U.S. Provisional Application No. 63/267,384, filed Jan. 31, 2022, titled “SYSTEMS AND METHODS FOR PREVENTING THE FORMATION OF CARBONYL SULFIDE,” the disclosures of which is incorporated herein by reference in its entirety.

Other objects, features and advantages of the disclosure will become apparent from the foregoing drawings, detailed description, and examples. These drawings, detailed description, and examples, while indicating specific embodiments of the disclosure, are given by way of illustration only and are not meant to be limiting. In further embodiments, features from specific embodiments may be combined with features from other embodiments. For example, features from one embodiment may be combined with features from any of the other embodiments. In further embodiments, additional features may be added to the specific embodiments described herein. It should be understood that although the disclosure contains certain aspects, embodiments, and optional features, modification, improvement, or variation of such aspects, embodiments, and optional features can be resorted to by those skilled in the art, and that such modification, improvement, or variation is considered to be within the scope of this disclosure.

What is claimed is:

1. A method for preventing formation of carbonyl sulfide in a production of sweet gas, the method comprising:
producing, via an amine absorption column supplied with a raw gas stream that includes fractions of hydrogen sulfide (H₂S), carbon dioxide (CO₂), and carbon monoxide (CO), (1) a sweet gas stream that includes the fractions of the CO and (2) an amine-rich aqueous solution that includes the H₂S and CO₂;
heating the amine-rich aqueous solution to produce a heated amine-rich aqueous solution;
producing, via an amine regenerator supplied with the heated amine-rich aqueous solution (1) an acid gas stream that includes the H₂S and CO₂ and (2) an amine-lean aqueous solution; and
producing, via adsorption in a metal oxide adsorbent vessel supplied with the acid gas stream, an effluent stream that includes the CO₂.

2. The method of claim 1, further comprising supplying the CO₂ for one or more of combustion, capture and sequestration, or for re-use.

3. The method of claim 2, further comprising, prior to supply of the CO₂ for re-use, purifying the CO₂.

4. The method of claim 1, wherein the amine-rich aqueous solution includes one or more of the H₂S or CO₂ as thermal labile salts, and wherein production of the acid gas stream occurs based on thermal breakdown of the thermal labile salts.

5. A method for preventing formation of carbonyl sulfide in a production of sweet gas, the method comprising:
supplying a raw gas stream that includes fractions of hydrogen sulfide (H₂S), carbon dioxide (CO₂), and carbon monoxide (CO) to an amine absorption column;
supplying an amine-lean aqueous solution to the amine absorption column, the amine-lean aqueous solution capable of absorbing the fractions of H₂S and CO₂;
operating the amine absorption column at a first selected temperature range and a first selected pressure range so that the amine-lean aqueous solution absorbs the fractions of the H₂S and CO₂ to produce (1) a sweet gas stream that includes the fractions of the CO and (2) an amine-rich aqueous solution that includes thermal labile salts produced based on an interaction between one or more of the fractions of the H₂S and CO₂ and the amine-lean aqueous solution;
outputting the sweet gas stream that includes the fractions of the CO for supply to a hydrogen facility;
supplying the amine-rich aqueous solution to a first heat exchanger to produce a heated amine-rich aqueous solution;
supplying the heated amine-rich aqueous solution to an upper portion of an amine regenerator;
operating the amine regenerator at a second selected temperature range and a second selected pressure range to effect thermal breakdown of the thermal labile salts to produce (1) an acid gas stream that includes the H₂S and CO₂ and (2) the amine-lean aqueous solution;
supplying the acid gas stream to a metal oxide adsorbent vessel capable of separating the H₂S and CO₂ by adsorption of the H₂S;
operating the metal oxide adsorbent vessel to adsorb the H₂S to produce an effluent stream that includes the CO₂,and
directing the effluent stream that includes the CO₂ to a combustion device.

6. The method of claim 5, further comprising:
supplying the amine-lean aqueous solution to a reboiler capable of heating the amine-lean aqueous solution to produce a heated amine-lean aqueous solution; and
supplying the heated amine-lean aqueous solution to the first heat exchanger so that the heated amine-lean aqueous solution cross-exchange heat with the amine-rich aqueous solution to output the heated amine-rich aqueous solution.

7. The method of claim 6, further comprising recycling the heated amine-lean aqueous solution to a second heat exchanger capable of cooling the heated amine-lean aqueous solution to output the amine-lean aqueous solution at a third selected temperature range to supply the upper portion of the amine absorption column with the amine-lean aqueous solution capable of adsorbing the fractions of the H₂S and CO₂.

8. The method of claim 5, wherein the raw gas stream comprises hydrogen, methane, ethane, propane, hydrogen sulfide, carbon monoxide, carbon dioxide, and mixtures thereof, wherein the sweet gas stream includes hydrogen, and wherein the metal oxide adsorbent vessel contains a metal oxide adsorbent material comprising copper oxide or iron oxide.

9. The method of claim 5, further comprising supplying one or more of an oxidant, steam, or water vapor to the amine regenerator to treat the amine-rich aqueous solution.

10. The method of claim 5, wherein the sweet gas stream is characterized by a total sulfur concentration that is substantially undetectable, and wherein the amine-rich aqueous solution that includes the thermal labile salts is characterized by a total CO concentration that is substantially undetectable.

11. A system for preventing formation of carbonyl sulfide in a production of sweet gas, the system comprising:
an amine absorption column positioned to receive (1) a raw gas stream that includes fractions of carbon monoxide (CO) and fractions of two or more contaminants including hydrogen sulfide (H₂S) and carbon dioxide (CO₂) at a portion of the amine absorption column and (2) an amine-lean aqueous solution at a portion of the amine absorption column, the amine absorption column includes packing or two or more trays to facilitate absorption of the fractions of the H₂S and the CO₂ at a first selected temperature range and a first selected pressure range to produce (a) a sweet gas stream that includes the fractions of the CO and (b) an amine-rich aqueous solution that includes thermal labile salts produced based on an interaction between one or more of the fractions of the two or more contaminants and the amine-lean aqueous solution;
a first heat exchanger positioned to receive the amine-rich aqueous solution from the amine absorption column, the first heat exchanger heating the amine-rich aqueous solution to produce a heated amine-rich aqueous solution;
an amine regenerator positioned to receive the heated amine-rich aqueous solution from the first heat exchanger, the amine regenerator including packing or two or more trays to reduce the fractions of the H₂S and CO₂ from the amine-rich aqueous solution at a second selected temperature range and a second selected pressure range to produce (1) a fluid stream that includes the amine-lean aqueous solution and (2) an acid gas stream that includes the fractions of the H₂S and the CO₂;
a metal oxide adsorbent vessel positioned to receive the fractions of the H₂S and CO₂, the metal oxide adsorbent vessel adsorbing the fractions of the H₂S to produce an effluent stream that includes the CO₂,and
downstream equipment positioned to receive CO₂ from the metal oxide adsorbent vessel for further use or processing.

12. The system of claim 11, wherein the raw gas stream comprises one or more of hydrogen, methane, ethane, propane, hydrogen sulfide, carbon monoxide, or carbon dioxide.

13. The system of claim 11, wherein the sweet gas stream comprises hydrogen and carbon monoxide.

14. The system of claim 11, further comprising a reboiler positioned to receive the fluid stream that includes the amine-lean aqueous solution from the amine regenerator, the reboiler configured to of heat the fluid stream that includes the amine-lean aqueous solution and to output a heated amine-lean aqueous solution to the first heat exchanger.

15. The system of claim 14, further comprising a second heat exchanger positioned to receive the heated amine-lean aqueous solution from the first heat exchanger, the second heat exchanger configured to cool the heated amine-lean aqueous solution and output the amine-lean aqueous solution at a third selected temperature range to an upper portion of the amine absorption column with the amine-lean aqueous solution.

16. The system of claim 15, wherein the third selected temperature range comprises about 25 degrees Fahrenheit to about 50 degrees Fahrenheit above a temperature of the raw gas stream that includes the fractions of the two or more contaminants supplied to the amine absorption column.

17. The system of claim 11, wherein the metal oxide adsorbent vessel contains a metal oxide adsorbent material comprising copper oxide or iron oxide.

18. The system of claim 11, wherein one or more of an oxidant, steam, water vapor, and combinations thereof is supplied to the amine regenerator to treat the amine-rich aqueous solution.

19. The system of claim 11, wherein the sweet gas stream is characterized by a total sulfur concentration that is substantially undetectable.

20. The system of claim 11, wherein the amine-rich aqueous solution includes the thermal labile salts from one or more of the two or more contaminants and is characterized by a total CO concentration that is substantially undetectable.

21. A system for preventing formation of carbonyl sulfide in a production of sweet gas, the system comprising:
an amine absorption column positioned to receive (1) a raw gas stream that includes fractions of carbon monoxide (CO) and fractions of two or more contaminants including hydrogen sulfide (H₂S) and carbon dioxide (CO₂) and (2) an amine-lean aqueous solution to facilitate absorption of the fractions of the H₂S and the CO₂ at a first selected temperature range and a first selected pressure range to produce (a) a sweet gas stream that includes the fractions of the CO to supply to a hydrogen facility and (b) an amine-rich aqueous solution that includes the fractions of the two or more contaminants;
a first heat exchanger positioned to receive the amine-rich aqueous solution from the amine absorption column, the first heat exchanger heating the amine-rich aqueous solution to produce a heated amine-rich aqueous solution;
an amine regenerator positioned to receive the heated amine-rich aqueous solution from the first heat exchanger to reduce the fractions of the H₂S and CO₂ from the amine-rich aqueous solution at a second selected temperature range and a second selected pressure range to produce (1) a fluid stream that includes the amine-lean aqueous solution and (2) an acid gas stream that includes the fractions of the H₂S and the CO₂, and
a metal oxide adsorbent vessel positioned to receive the fractions of the H₂S and CO₂, the metal oxide adsorbent vessel adsorbing the fractions of the H₂S to produce an effluent stream including the CO₂.

22. The system of claim 21, wherein an interaction between the amine-lean aqueous solution and the two or more contaminants generates thermal labile salts, and wherein the amine-rich aqueous solution includes the thermal labile salts.

23. The system of claim 21, further comprising a reboiler positioned to receive the fluid stream that includes the amine-lean aqueous solution from the amine regenerator, the reboiler configured to heat the fluid stream that includes the amine-lean aqueous solution and to output a heated amine-lean aqueous solution to the first heat exchanger.

24. The system of claim 23, further comprising a second heat exchanger positioned to receive the heated amine-lean aqueous solution from the first heat exchanger, the second heat exchanger configured to cool the heated amine-lean aqueous solution and to output the amine-lean aqueous solution at a third selected temperature range to an upper portion of the amine absorption column with the amine-lean aqueous solution.

25. The system of claim 21, wherein the first selected temperature range comprises about 95 degrees Fahrenheit to about 150 degrees Fahrenheit and the first selected pressure range comprises about 5 standard atmosphere (atm) of absolute pressure to about 20 standard atm of absolute pressure, and
wherein the second selected temperature range comprises about 225 degrees Fahrenheit to about 275 degrees Fahrenheit and the first selected pressure range comprises about 1 pounds per square inch gauge (PSIG) to about 15 PSIG.

26. The system of claim 24, wherein the third selected temperature range is from about 25 degrees Fahrenheit to about 50 degrees Fahrenheit above a temperature of the raw gas stream that includes the fractions of the two or more contaminants supplied to the amine absorption column.

27. The system of claim 21, wherein the raw gas stream comprises one or more of hydrogen, methane, ethane, propane, hydrogen sulfide, carbon monoxide, or carbon dioxide; wherein the sweet gas stream comprises hydrogen and carbon monoxide, and wherein the acid gas stream comprises H₂S and CO₂.

28. The system of claim 21, wherein the amine-lean aqueous solution comprises one or more of monoethanolamine (MEA), diethanolamine (DEA), 2-amino-2-methylpropanol (AMP), methyldiethanolamine (MDEA), piperazine (PIPA) and combinations thereof, and wherein the metal oxide adsorbent vessel contains a metal oxide adsorbent material comprising copper oxide or iron oxide.

29. The system of claim 21, wherein the amine regenerator receives one or more of an oxidant, steam, or water vapor to treat the amine-rich aqueous solution.

30. The system of claim 22, wherein the amine-rich aqueous solution that includes the thermal labile salts from one or more of the two or more contaminants includes a total CO concentration that is substantially undetectable.
